(19) United States
(12) Patent Application Publication
(10) Pub. No.: US 2022/0385625 A1
(43) Pub. Date: Dec. 1, 2022

(54) METHOD FOR TRANSMITTING DATA IN A NETWORK SYSTEM AS WELL AS A NETWORK SYSTEM

(71) Applicant: dSPACE GmbH, Paderborn (DE)

(72) Inventors: Stephan SCHEDLER, Paderborn (DE); Moritz SCHNIEDERMANN, Paderborn (DE); Carsten IGEL, Paderborn (DE)

(73) Assignee: dSPACE GmbH, Paderborn (DE)

(21) Appl. No.: 17/826,982

(22) Filed: May 27, 2022

(30) Foreign Application Priority Data
May 27, 2021 (DE) 10 2021 113 670.9

(51) Int. Cl. H04L 61/2592; H04L 61/5007; H04L 12/46; H04L 45/74

(52) U.S. Cl. CPC H04L 61/2592; H04L 61/5007; H04L 12/4633; H04L 45/74

(57) ABSTRACT

A method for transmitting data in a network system and a network system having an operation of a network controller of a fourth network element in a promiscuous mode, and a generation of an IP tunnel between the first network and the second network, the third network element and the fourth network element being particular end points of the IP tunnel guided via an access element.

This nonprovisional application claims priority under 35 U.S.C. § 119(a) to German Patent Application No. 10 2021 113 670.9, which was filed in Germany on May 27, 2021, and which is herein incorporated by reference.

### BACKGROUND OF THE INVENTION

### Field of the Invention

The present invention relates to a method for transmitting data in a network system. The present invention also relates to a corresponding network system.

### Description of the Background Art

A conventional first user network node/destination network node scenario without the presence of a cluster is, for example, made up of an individual user network node, for example a browser on a desktop PC, which requests a service, such as to download an HTML page, and a destination network node, such as a web server, which provides the requested service.

The user network node and the destination network node host the corresponding applications and are connected to the same network via Ethernet interfaces, e.g., “eth0.” To be able to use the service, the user network node must know the service address, which is made up of the destination network node IP address, e.g., 192.168.0.1, and a service port, e.g., 80 for HTTP connections or 443 for HTTPS connections.

The port is needed to identify the service application which is operated on the destination network node. To be able to receive replies from the destination network node, the user network node has its own user IP address and listens at the user port.

For this purpose, the service provider normally uses a predefined static port, since this port must be known to each user in order to initiate a connection. The user port, however, may be dynamically generated, since it may be made known to the provider during the first connection request of the user.

The basic idea of cloud computing is to instantiate hundreds or even thousands of service applications on demand, each of which runs encapsulated in a runtime environment, e.g., in a container or a virtual machine. A common example of a service application of this type is a web server application, which listens for HTTP or HTTPS requests on a predefined port.

Alternatively, the destination network node may be operated, for example, in another (sub-)network within the scope of a second user network node/destination network node scenario. The two nodes no longer have a direct connection, i.e., the user network node may not reach the destination network node directly and vice versa. A simple example of a structure of this type is a cluster, in which the destination network node is instantiated in the cluster, and the user network node is operated outside the cluster.

The two nodes are connected to different networks, which are referred to below as internal and external networks. An access node exists, which has access to both networks, the cluster-internal and the cluster-external network. Instead of sending a service request to the destination IP and the service port, the initial connection request is sent from the user network node to the IP and the access port of the access node, from where, in turn, it is sent to the IP and the access port of the cluster node or destination network node.

The destination network node is configured in such a way that it makes the service available to the external network at the access port, i.e., each request from the user network node of the external network to the access port is forwarded to the service port of the destination network node in the internal network.

In the two application scenarios mentioned above, the first connection request is directed to a static (known) port. In the first application scenario, further dynamically assigned ports may be used in the subsequent communication. For this purpose, new ports may be dynamically assigned by applications on the destination network node, and the existing, initial communication path may be used to signal the availability of the new ports and the associated services to the user network node.

However, this is not possible in the second application scenario. Even if new ports in the destination network node may be dynamically assigned, they are not accessible from the external network. The release of ports, i.e., a port forwarding, normally requires a static configuration.

This problem is not relevant for service applications designed for execution in a cluster. However, if one has an existing application which uses dynamic ports, this may result in considerable costs if it is necessary to port the application from the first application scenario to the second application scenario.

At the present time, it is not possible to operate applications which require a dynamic port assignment, using common container orchestration software, such as Kubernetes, if the dynamic port must be reachable from outside the cluster.

### SUMMARY OF THE INVENTION

It is therefore an object of the present invention to provide a method for transmitting data in a network system as well as a corresponding network system, which make it possible to operate applications requiring a dynamic port assignment in a cluster environment restricted by user rights.

The invention relates to a method for transmitting data in a network system. The method comprises a provision of a first network element, in particular a user network node, connected to a first network and a second network element, in particular a destination network node, connected to a second network, in particular a cluster network, the second network element not having the user right to generate a virtual network interface.

The method furthermore comprises a provision of a physical or virtual third network element connected to the first network, and a physical or virtual fourth network element connected to the second network.

Moreover, the method comprises an operation of a network controller of the fourth network element in a promiscuous mode and a generation of an IP tunnel between the first network and the second network, the third network element and the fourth network element being particular end points of the IP tunnel guided via an access element.

The invention also relates to a further method for transmitting data in a network system, comprising a provision of a first network element, in particular a user network node, connected to a first network and a second network element, in particular a destination network node, connected to a second network, in particular a cluster network, the second network element not having the user right to generate a virtual network interface.

The method also comprises a provision of a physical or virtual third network element connected to the second network as well as an operation of a network controller of the third network element in a promiscuous mode.

Moreover, the method comprises a generation of an IP tunnel between the first network and the second network, the first network element and the third network element being particular end points of the IP tunnel guided via an access element.

The invention furthermore relates to a network system for transmitting data between a first network element and a second network element, comprising a first network element, in particular a user network node, connected to a first network.

The network system also comprises a second network element, in particular a destination network node, which is connected to a second network, in particular a cluster network, the second network element not having the user right to generate a virtual network interface.

Moreover, the network system comprises a physical or virtual third network element connected to the first network and a physical or virtual fourth network element connected to the second network, a network controller of the fourth network element being operable in a promiscuous mode, and the third network element and the fourth network element being particular end points of an IP tunnel guided via an access element.

The invention also relates to a further network system for transmitting data between a first network element and a second network element, comprising a first network element, in particular a user network node, connected to a first network.

The network system also comprises a second network element, in particular a destination network node, which is connected to a second network, in particular a cluster network, the second network element not having the user right to generate a virtual network interface.

Moreover, the network element comprises a physical or virtual third network element connected to the second network, a network controller of the third network element being operable in a promiscuous mode, an IP tunnel being generated between the first network and the second network, the first network element and the third network element being particular end points of the IP network guided via an access element.

One idea of the invention is thus to generate an IP tunnel for Ethernet frames, when user and/or destination nodes are operated in a restricted environment which does not permit the setup of conventional IP tunnels.

Ethernet frames, which are transmitted by the user network node and are destined for the destination network node, must be detected in the external network and injected into the internal network as well as vice versa.

Within the scope of the invention, therefore, virtual Ethernet devices or network elements are inserted into the internal and external networks, which are responsible for detecting, forwarding and inserting the corresponding Ethernet packets.

However, this must take place with limited capabilities, e.g. available for nodes which are operated in a cluster.

In the aforementioned second application scenario, the invention adds two tunnel end points, a tunnel client node, i.e. the third network element, and a tunnel server node, i.e. the fourth network element. The tunnel server node and the tunnel client node may be alternatively arranged, for example in reverse order than explained in the present example.

The server node is placed within the internal network with a static port, which is opened via the access node. In the uplink, the tunnel client node intercepts the entire traffic of the external network, in that it places its Ethernet device or its virtual network interface/network element into a promiscuous mode and sniffs incoming packets. The term, sniff, relates to the fact that all packets are filtered in a targeted manner according to packets having the desired address. The functionality of sniffing is possible only if the Ethernet device is in promiscuous mode.

Alternatively, the Ethernet device of the corresponding network node of the external network may be operated, for example, in a non-promiscuous mode. In this case, the user network node is equipped with a further network device, in particular a virtual TAP network interface. In the external network, the user network node has the user right to generate a virtual network interface.

The packets destined for the destination network node from the user network node are forwarded to the tunnel server node (via the access node). The server node also uses a promiscuous mode to transmit the tunneled Ethernet frames to the internal network, so that the destination network node can receive them.

The tunnel client node is not necessarily limited to the same restricted authorizations. If the client node has the necessary capabilities, it may use, for example, an existing IP tunnel implementation. For compatibility reasons, however, it may be sensible to use the same tunnel (and IP stack) implementation in both tunnel end points.

The core idea of the invention is thus to add a server node in the restricted environment and to use the promiscuous mode in its Ethernet controller to set up an IP tunnel to the external network.

This is also possible in restricted environments, such as clusters, since capabilities other than the generation of traditional IP tunnels are necessary, which are usually granted user space applications to send/receive Ethernet frames without IP protocols such as ICMP frames, e.g. “ping.”

In Linux-based systems, this requires, for example, NET_RAW capabilities in the server node. The use of this capability within the cluster is possible as standard, since this capability is also required by basic Linux network utilities, such as “ping,” to generate ICMP frames.

In the invention, use is made of this capability to generate a user space tunnel end point or IP tunnel end point for the internal network in the cluster, which intercepts the Ethernet frames in the internal network (from the destination network node to the user network node), forwards these packets to the other tunnel end point in the external network as well as receives Ethernet frames (from the user network node to the destination network node) from the other IP tunnel end point, and feeds these frames into the internal network.

The tunnel client node may be implemented in the equivalent manner. However, if this is not tied to the same restricted rights, it may use, for example, existing IP tunnel implementations.

An implementation of the invention temporarily requires NET_ADMIN capabilities in the server node on Linux-based system in order to place its Ethernet device into promiscuous mode.

In a cluster, this capability must be added to the server node when it is generated. Since it is needed only upon startup, the corresponding process may delete the capability again after startup.

In order for an IP communication to function, all communication partners (nodes) must know the IP and MAC (/hardware) addresses of the other node. Since the MAC addresses are initially unknown, ARP broadcast requests are sent as the first step of every IP communication.

In order for IP packets in the external network to be routed from the user network node via network switches to the client node, the client node must answer ARP requests of the user network node which are destined for the destination network node. Similarly, the server node must answer ARP requests from the destination network node which are destined for the user network node.

Depending on the routing policy in the internal network, the server node may not be permitted to send or forward packets from the user network node, since they do not correspond to the IP and MAC addresses assigned to the server node (IP spoofing).

In this case, the server node must hide the IP and MAC addresses of the user network node by replacing the addresses and checksums in the raw Ethernet frame with its own addresses.

If the IP of the user node is disguised, i.e., the packets of the user node are forwarded with the IP and MAC addresses of the server node, the IP stack in the Linus kernel of the server node must be deactivated, since it would answer each received IP packet even if it is destined for the user node.

This may be achieved, for example, by deleting the IP address in the server node after startup. If the Ethernet interface of the server node is in promiscuous mode, the tunnel server application may continue detecting and sending Ethernet frames.

An implementation on Linux-based systems temporarily requires NET_ADMIN capabilities to delete the IP address of the server node. This capability is required only upon startup and may be deleted after startup.

If the IP address of the server node is omitted, this results in a new problem. Since the local kernel IP stack no longer processes any received packets, a user space IP stack implementation is needed in the tunnel application to generate and parse tunnel packets to and from the client node.

In addition, the tunnel application must be able to distinguish between detected frames from the client node (tunnel frames) and detected frames from the provider node (frames to be tunneled). This may be easily achieved by evaluating the source MAC address in the Ethernet header.

The invention thus offers a plurality of advantages, such as transparency, i.e., the approach does not change either the configuration of the destination and/or user network nodes or their implementations, i.e., no effort is added for porting service applications to a cluster setup having restricted user rights.

Moreover, a standard cluster configuration may be selected, i.e., there is no need to change the configuration of clusters or the implementation of clusters, e.g., by adding network plug-ins such as multus-cni for Kubernetes.

If the cluster is not hosted on the user's own servers, but instead third-party cluster services are used, the user may under certain circumstances not have sufficient authorization to change the configuration of the cluster.

The approach according to the invention may therefore be implemented with restricted rights, which are usually available to the nodes in a cluster.

A network node is an entity which is connected to at least one Ethernet (sub)-network. This may be, for example, a Docker container, a Kubernetes pod, a virtual machine, a physical PC or a composition or assembly of multiple nodes. The network node has a unique IP in connected Ethernet (sub)-network(s). The term, network node, is not used synonymously with the cluster term, master/worker node.

A computer cluster or cluster network is a group of loosely or closely interconnected computers, which work together in such a way that they may in many respects be viewed as a single system.

The cluster is managed by container orchestration software, e.g., Kubernetes, which is responsible for a provision of containers, a scaling, a dynamic resource assignment (such as computing power, network, memory), a reliability, a load compensation, a data traffic management and a data security.

The second network element, in particular the cluster network, does not generally have the user right to generate a virtual network interface. The reason for this is that the service provider of the cluster network usually grants the user only limited user rights for security reasons, since a multiplicity of users share the existing resources when cluster networks of this type are hosted in a cloud environment.

The promiscuous mode is a mode for network interface controllers, which induces the controller to forward the entire data traffic it receives to a central processing unit (CPU) instead of only the frames for whose receipt the controller is specifically programmed.

The message is a communication packet, i.e. a first or inner bitstream. An envelope, in which a network element packages a message, is a UDP packet or an outer bitstream. The first or inner bitstream is then packaged in the envelope, i.e., the UDP packet or outer bitstream.

An IP tunnel is a network communication channel of the Internet protocol between two networks. It is used to transport another network protocol by encapsulating its packets. In IP tunneling, each IP packet, including the addressing information of its source and destination IP network, is encapsulated into a different packet format native to the transit network.

A first message can be sent to the first network by the first network element, the first message being addressed to an IP address and a port of the second network element or to an IP address and a port of another network element, which is converted into an IP address and a port of the second network by a further network element, in particular the third network element and/or fourth network element.

The third network element can receive packets of the first message arriving in the first network, the third network element packaging the first message in a first envelope, and a network controller of the third network element being operated in a promiscuous mode or a non-promiscuous mode.

The network controller of the third network element thus receives the first message generated by the user network node and packages it in the first envelope.

The first message packaged in the first envelope can be addressed to a first tunnel port of the access element and is sent from the third network element to the first tunnel port of the access element. The access element advantageously makes it possible to transmit the first message from the first network to the second network.

The first tunnel port of the access element can be preconfigured in such a way that the first tunnel port automatically sends incoming messages to the physical or virtual fourth network element, in particular a server network node. An efficient communication with the fourth network element may thus be advantageously achieved.

The physical or virtual fourth network element, in particular the server network node, can unpack the first message received from the access element and packaged in the first envelope, and the unpacked first message is sent from the fourth network element to the second network element, in particular the destination network node, via the second network, using the promiscuous mode. The first message may thus be sent from the user network node to the destination network node via the third network element and the fourth network element, using the IP tunnel.

A second message can be sent to the second network from the second network element, using a dynamically assigned port of the second network element, the second message being addressed to an IP address and a port of the first network element.

The fourth network element can receive, in particular sniffs, packets of the second message arriving in the second network, using the promiscuous mode of the network controller of the fourth network element, the fourth network element packaging the second message in a second envelope. The network controller of the fourth network element thus receives the second message generated by the destination network node and packages it in the second envelope.

The second message packaged in the second envelope can be addressed to a second tunnel port of the access element and is sent from the fourth network element to the second tunnel port of the access element.

The access element advantageously makes it possible to transmit the second message from the second network to the first network.

The second tunnel port of the access element can be dynamically configured, in particular at runtime, using information from the first message, in such a way that the second tunnel port automatically sends incoming messages to the physical or virtual third network element, in particular a client network node. An efficient communication with the third network element may thus be advantageously achieved.

The physical or virtual third network element, in particular the client network node, can unpack the second message received from the access element and packaged in the second envelope, the unpacked second message being sent from the third network element to the first network element, in particular the user network node, via the first network.

The second message may thus be sent from the destination network node to the user network node via the fourth network element and the third network element, using the IP tunnel.

The first message can have a sender IP and MAC address of the first network element, the third network element or the fourth network element replacing the sender IP and MAC address of the first network element with an IP and MAC address of the fourth network element. The first message may thus be advantageously addressed to the destination network node by the circuitous route of the third or fourth network element.

The second message can have a receiver IP and MAC address, in particular the fourth network element, one of the end points of the IP tunnel, in particular the first network element, the third network element or the fourth network element, replacing the receiver IP and MAC address of the second message with an IP and MAC address of the first network element. The second message may thus be advantageously addressed to the user network node by the circuitous route of the third or fourth network element.

The method described herein for transmitting data in a network system is likewise applicable to the network system according to the invention and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a flowchart of a method for transmitting data in a network system as well as an underlying network system according to one preferred specific embodiment of the invention; and

FIG. 2 shows a flowchart of the method for transmitting data in the network system as well as the underlying network system according to a further preferred specific embodiment of the invention.

### DETAILED DESCRIPTION

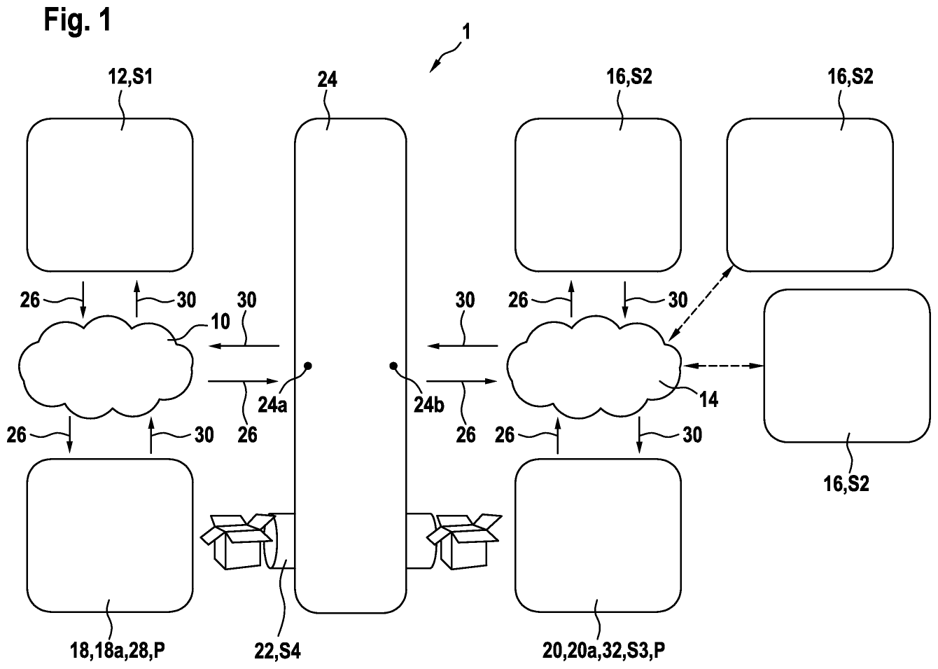

The method shown in FIG. 1 for transmitting data in a network system 1 comprises a provision 51 of a first network element 12, in particular a user network node, connected to a first network 10 and a second network element 16, in particular a destination network node, connected to a second network 14, in particular a cluster network. Second network element 16 does not have the user right to generate a virtual network interface.

The method furthermore comprises a provision S2 of a virtual third network element 18 connected to first network 10 and a virtual fourth network element 20 connected to second network 14. Third network element 18 and fourth network element 20 may alternatively be provided, for example, with a physical design.

First network element 12 is connected to first network 10 via a first network controller. Second network element 16 is connected to second network 14 via a second network controller.

Moreover, the method comprises an operation S3 of a network controller 20a of fourth network element 20 in a promiscuous mode P, and a generation S4 of an IP tunnel 22 between first network 10 and second network 14, third network element 18 and fourth network element 20 being particular end points of IP tunnel 22 guided via an access element 24.

A first message 26 is first sent from first network element 12 to first network 10. First message 26 is addressed to an IP address and a port of second network element 16.

Alternatively, first message 26 may be addressed, for example, to an IP address and a port of another network element, which is converted by a further network element, in particular, third network element 18 and/or fourth network element 20, into an IP address and a port of second network element 16.

Third network element 18 receives packets of first message 26 arriving in first network 10. Third network element 18 furthermore packages first message 26 in a first envelope 28. According to the present specific embodiment, a network controller 18a of third network element 18 is operated in a promiscuous mode P. Alternatively, the network controller may, for example, be operated in a non-promiscuous mode.

First message 26 packaged in first envelope 28 is addressed to a first tunnel port 24a of access element 24 and is sent from third network element 18 to first tunnel port 24a of access element 24.

First tunnel port 24a of access element 24 is preconfigured in such a way that first tunnel port 24a automatically sends incoming messages to virtual fourth network element 20, in particular a server network node.

Virtual fourth network element 20, in particular the server network node, unpacks first message 26 received from access element 24 and packaged in first envelope 28. Unpacked first message 26 is furthermore sent from fourth network element 20 to second network element 16, in particular the destination network node, via second network 14, using promiscuous mode P.

A second message 30 is sent from second network element 16 to second network 14, using a dynamically assigned port of second network element 16. Second message 30 is addressed to an IP address and a port of first network element 12.

Fourth network element 20 receives, in particular sniffs, packets of second message 30 arriving in second network 14, using promiscuous mode P of network controller 20a of fourth network element 20. Fourth network element 20 furthermore packages second message 30 in a second envelope 32.

Second message 30 packaged in second envelope 32 is addressed to a second tunnel port 24b of access element 24 and is sent from fourth network element 20 to first tunnel port 24b of access element 24.

Second tunnel port 24b of access element 24 is dynamically configured, in particular at runtime, using information from first message 26, in such a way that second tunnel port 24b automatically sends incoming messages to physical or virtual third network element 18, in particular the client network node.

Virtual third network element 18, in particular the client network node, unpacks second message 30 received from access element 24 and packed into second envelope 32. Unpacked second message 30 is sent from third network element 18 to first network element 12, in particular the user network node, via first network 10.

First message 26 has an IP and MAC address of first network element 12, third network element 18 or fourth network element 20 replacing the IP and MAC address of first network element 12 with an IP and MAC address of fourth network element 20. The IP and MAC address of the first network element is a sender IP and MAC address.

Second message 30 furthermore has a receiver IP and MAC address, in particular fourth network element 20. One of the end points of IP tunnel 22, in particular first network element 12, third network element 18 or fourth network element 20, replaces the receiver IP and MAC address of second message 30 with an IP and MAC address of first network element 12.

Network system 1 shown in FIG. 1 for transmitting data between a first network element 12 and a second network element 16 comprises a first network element 12, in particular a user network node, connected to a first network 10 and a second network element, in particular a destination network node, connected to a second network 14, in particular a cluster network.

Second network element 16 does not have the user right to generate a virtual network interface. Network system 1 also comprises a virtual third network element connected to first network 10 and a virtual fourth network element connected to second network 14.

Third network element 18 and fourth network element 20 may alternatively be provided, for example, with a physical design. A network controller 20a of fourth network element 20 may be operated in a promiscuous mode P. In addition, third network element 18 and fourth network element 20 are particular end points of an IP tunnel 22 guided via an access element 24.

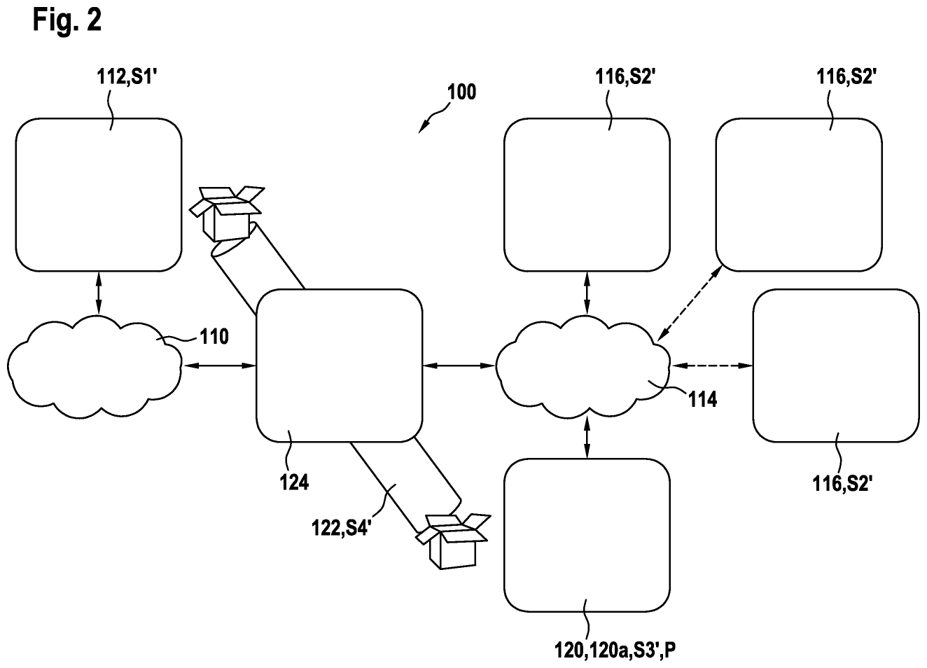

FIG. 2 shows a flowchart of the method for transmitting data in a network system as well as the underlying network system according to a further preferred specific embodiment of the invention.

The method comprises a provision 51′ of a first network element 112, in particular a user network node, connected to a first network 10, and a second network element 116, in particular a destination network node, connected to a second network, 114 in particular a cluster network, second network element 116 not having the user right to generate a virtual network interface.

The method also comprises a provision S2′ of a physical or virtual third network element 120 connected to second network 114 as well as an operation S3′ of a network controller 120a of third network element 120 in a promiscuous mode P′.

Moreover, the method comprises a generation S4′ of an IP tunnel 122 between first network 110 and second network 114, first network element 112 and third network element 120 being particular end points of IP tunnel 122 routed via an access element 124.

Apart from the modified network architecture of this specific embodiment, the network communication takes place similarly to the method illustrated in FIG. 1. These steps will therefore not be repeated.

Network system 1 shown in FIG. 2 for transmitting data between a first network element 12 and a second network element 16 comprises a network system 100 for transmitting data between a first network element 112 and a second network element 116, comprising a first network element, in particular a user network node, connected to a first network 110, and a second network element, in particular a destination network node, connected to a second network 114, in particular a cluster network.

Second network element 116 does not have the user right to generate a virtual network interface.

Network system 1 further comprises a virtual third network element connected to second network 114, a network controller 120a of third network element 120 being operable in a promiscuous mode P′.

An IP tunnel 122 is generated between first network 110 and second network 114, first network element 112 and third network element 120 being particular end points of IP tunnel 122 guided via an access element 124.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for transmitting data in a network system, the method comprising:
providing a first network element connected to a first network;
providing a second network element connected to a second network or a cluster network, the second network element not having a user right to generate a virtual network interface;
providing a physical or virtual third network element connected to the first network and a physical or virtual fourth network element connected to the second network;
operating a network controller of the fourth network element in a promiscuous mode; and
generating an IP tunnel between the first network and the second network,
wherein the third network element and the fourth network element are particular end points of the IP tunnel that is guided via an access element.

2. The method according to claim 1, wherein a first message is sent from the first network element to the first network, the first message being addressed to an IP address and a port of the second network element or to an IP address and a port of another network element, which is converted into an IP address and a port of the second network element by a further network element or by the third network element and/or the fourth network element.

3. The method according to claim 1, wherein the third network element receives packets of the first message arriving in the first network, the third network element packaging the first message in a first envelope, and a network controller of the third network element being operated in a promiscuous mode or a non-promiscuous mode.

4. The method according to claim 3, wherein the first message packaged in the first envelope is addressed to a first tunnel port of the access element and is sent from the third network element to the first tunnel port of the access element.

5. The method according to claim 4, wherein the first tunnel port of the access element is preconfigured such that the first tunnel port automatically sends incoming messages to the physical or virtual fourth network element.

6. The method according to claim 3, wherein the physical or virtual fourth network element, unpacks the first message received from the access element and packaged in the first envelope, and wherein the unpacked first message is sent from the fourth network element to the second network element via the second network using the promiscuous mode.

7. The method according to claim 1, wherein a second message is sent to the second network from the second network element using a dynamically assigned port of the second network element, the second message being addressed to an IP address and a port of the first network element.

8. The method according to claim 1, wherein the fourth network element sniffs packets of the second message arriving in the second network using the promiscuous mode of the network controller of the fourth network element, and wherein the fourth network element packages the second message in a second envelope.

9. The method according to claim 8, wherein the second message packaged in the second envelope is addressed to a second tunnel port of the access element and is sent from the fourth network element to the second tunnel port of the access element.

10. The method according to claim 9, wherein the second tunnel port of the access element is dynamically configured at runtime using information from the first message such that the second tunnel port automatically sends incoming messages to the physical or virtual third network element.

11. The method according to claim 7, wherein the physical or virtual third network element, unpacks the second message received from the access element and packaged in the second envelope, and wherein the unpacked second message is sent from the third network element to the first network element via the first network.

12. The method according to claim 1, wherein the first message has a sender IP and MAC address of the first network element, and wherein the third network element or the fourth network element replaces the sender IP and MAC address of the first network element with an IP and MAC address of the fourth network element.

13. The method according to claim 1, wherein the second message has a receiver IP and MAC address, in particular the fourth network element, and wherein the first network element, the third network element or the fourth network element replaces the receiver IP and MAC addresses of the second message with an IP and MAC address of the first network element.

14. A method for transmitting data in a network system, the method comprising:
providing a first network element connected to a first network;
providing a second network element connected to a second network, the second network element not having a user right to generate a virtual network interface;
providing a physical or virtual third network element connected to the second network;
operating a network controller of the third network element in a promiscuous mode; and
generating an IP tunnel between the first network and the second network, the first network element and the third network element being particular end points of the IP tunnel guided via an access element.

15. A network system for transmitting data between a first network element and a second network element, the network system comprising:
a first network element connected to a first network;
a second network element connected to a second network, the second network element not having a user right to generate a virtual network interface;
a physical or virtual third network element connected to the first network; and
a physical or virtual fourth network element connected to the second network, a network controller of the fourth network element being operable in a promiscuous mode, and the third network element and the fourth network element being particular end points of an IP tunnel guided via an access element.

16. A network system for transmitting data between a first network element and a second network element, the network system comprising:
a first network element connected to the first network;
a second network element connected to a second network, the second network element not having a user right to generate a virtual network interface; and
a physical or virtual third network element connected to the second network, a network controller of the third network element being operable in a promiscuous mode, an IP tunnel being generated between the first network and the second network, the first network element and the third network element being particular end points of the IP network guided via an access element.

17. The method according to claim 1, wherein the first network element is a user network node, and wherein the second network element is a destination network node.
